(19) United States
(12) Patent Application Publication
(10) Pub. No.: US 2009/0241551 A1
(43) Pub. Date: Oct. 1, 2009

(54) Cogeneration of Hydrogen and Power

(75) Inventor: Bhadra S. Grover, Sugar Land, TX (US)

Correspondence Address: AIR LIQUIDE;Intellectual Property, 2700 POST OAK BOULEVARD, SUITE 1800, HOUSTON, TX, 77056, US

(73) Assignee: AIR LIQUIDE PROCESS AND CONSTRUCTION Inc., Houston, TX (US)

(21) Appl. No.: 12/410,487

(22) Filed: Mar. 25, 2009

Related U.S. Application Data
(60) Provisional application No. 61/039,470, filed on Mar. 26, 2008.

(51) Int. Cl. F02C 6/10

(52) U.S. Cl. 60/780

(57) ABSTRACT

A process for the integration of power generation and an SMR, including introducing a combustion air stream into a compressor, thereby producing a compressed air stream. The compressed air stream is then introduced, along with a combustor feed gas stream into a first combustor, thereby producing a first exhaust gas stream. The first exhaust gas stream is then introduced into the shell-side of an SMR, thereby providing the heat for the reforming reaction, and generating a syngas stream and a second exhaust gas stream. The second exhaust gas stream is introduced, along with a secondary fuel stream, into a second combustor, thereby producing a third exhaust gas stream. The third exhaust gas stream is then introduced into an expander, thereby producing power output and a fourth exhaust gas stream.

### CROSS-REFERENCE TO RELATED APPLICATIONS

This application claims the benefit of U.S. Provisional Application No. 61/039,470, filed Mar. 26, 2008, the entire contents of which are incorporated herein by reference.

### BACKGROUND

Gas turbines are often located at synthesis gas production sites. It is typical for the fuel for both the gas turbine and the hydrocarbon containing reactant fed for the synthesis gas production to be natural gas. Where such installations exist, the gas turbines are not normally thermally linked to the synthesis gas production. In integrated gasification combined cycles, however, the gas turbine and the synthesis gas production are both thermally and operationally linked in that the fuel to the gas turbine is the synthesis gas and the synthesis gas is reheated through heat transfer with the synthesis gas stream being produced.

In the present invention the gas turbine is combined with the SMR to generate power, hydrogen, and steam. This cogeneration scheme improves overall thermal efficiency of the process. It reduces the amount of by-product steam. The hydrogen generation is done in an exchanger type of reactor that is much more compact as compared to a conventional SMR furnace

### SUMMARY

A process for the integration of power generation and an SMR, including introducing a combustion air stream into a compressor, thereby producing a compressed air stream. The compressed air stream is then introduced, along with a combustor feed gas stream into a first combustor, thereby producing a first exhaust gas stream. The first exhaust gas stream is then introduced into the shell-side of an SMR, thereby providing the heat for the reforming reaction, and generating a syngas stream and a second exhaust gas stream. The second exhaust gas stream is introduced, along with a secondary fuel stream, into a second combustor, thereby producing a third exhaust gas stream. The third exhaust gas stream is then introduced into an expander, thereby producing power output and a fourth exhaust gas stream.

### BRIEF DESCRIPTION OF DRAWINGS

The invention may be understood by reference to the following description taken in conjunction with the accompanying drawings, and in which:

FIG. 1 is a schematic representation of one embodiment of the present invention.

FIG. 2 is a schematic representation of another embodiment of the present invention.

FIG. 3 is a schematic representation of one embodiment of the present invention.

FIG. 4 is a schematic representation of another embodiment of the present invention.

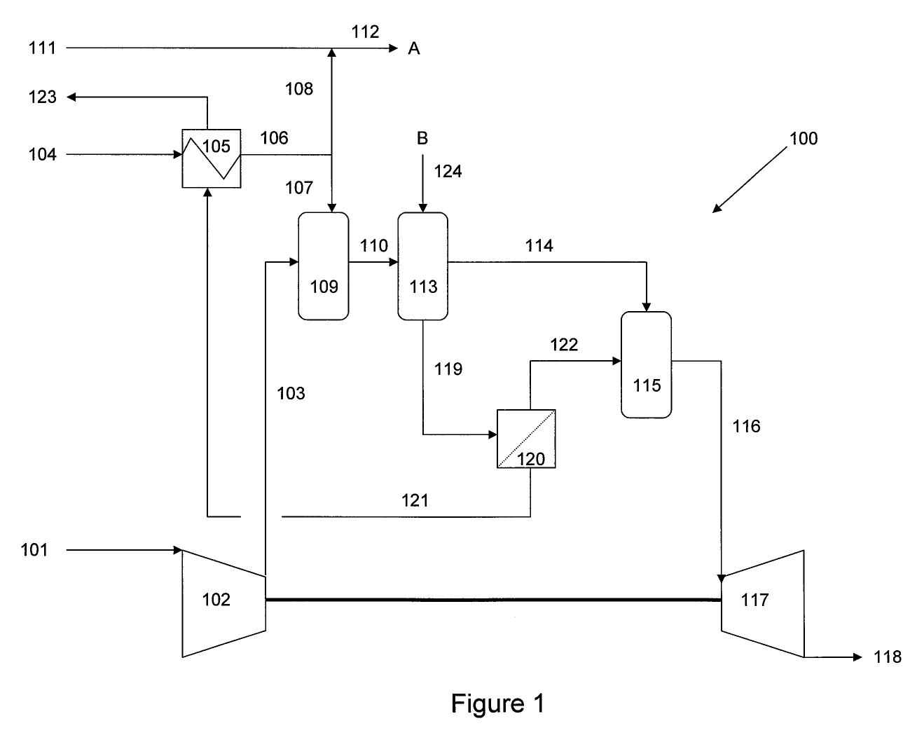

FIGS. 1a-4a are schematic representations of another embodiment of the present inventions, as described in FIGS. 1-4.

### DESCRIPTION OF PREFERRED EMBODIMENTS

Turning now to FIG. 1, combined SMR and cogeneration system 100 is provided. Combustion air stream 101 is introduced to air compressor 102, where it is compressed and exits as compressed air stream 103. Natural gas stream 104 introduced into natural gas pre-heater 105, where it exits as heated natural gas stream 106. Natural gas stream 104 may be purified if necessary. Heated natural gas stream 106 is divided into at least two portions, combustor feed gas stream 107 and SMR feed gas stream 108. Combustor feed gas stream 107 is combined with compressed air stream 103 in first combustor 109, where it is combusted, thereby generating first exhaust gas stream 110. First exhaust gas stream 110 may have a temperature of between about 2000 F. and about 2200 F. Steam stream 111, is combined with SMR feed gas stream 108, to form combined feed stream 112. Combined feed stream 112 is further preheated in a mixed feed preheater section of waste heat boiler 128 (shown in FIG. 1a). Preheated combined feed stream 124 is introduced into SMR 113, where it exits as syngas stream 119. Syngas stream 119 may have a temperature of between about 1200 F. and about 1600 F. In one embodiment, SMR 113 may be of the type known as an exchanger type, which has no burners to supplement the heat content of first exhaust gas stream 110. In another embodiment, SMR 113 may have burners (not shown) to supplement the heat content of first exhaust gas stream 110, as needed. First exhaust gas stream 110 is introduced into the shell-side of SMR 113, where it provides the heat required for the steam reforming process, then exiting as second exhaust gas stream 114. Syngas stream 119 is introduced into filter 120, where it is separated into hot hydrogen product stream 121 and secondary fuel stream 122. Filter 120 may be a ceramic or metallic separator. Secondary fuel stream 122 may contain one or more of the following, unconverted methane, unrecovered H2, CO, CO2, and unused steam. The metallic separator may utilize palladium. Second exhaust gas stream 114 is combined with secondary fuel stream 122 in second combustor 115 where it is combusted, thereby generating third exhaust gas stream 116. Third exhaust gas stream 116 is introduced into expander 117, where it is expanded and exits as fourth exhaust gas stream 118. Fourth exhaust gas stream 118 may have a temperature of between about 800 F. and about 1100 F. Fourth exhaust gas stream 118 is used for preheating mixed feed stream 112, and for generating steam. Boiler feed water stream 125 is introduced into waste heat boiler 128, wherein it is heated, vaporized, and superheated into steam stream 126. Steam stream 126 may be used to feed the SMR (stream 111), with any remaining steam being available for exportation, or for power generation in a steam turbine (not shown).

Hot hydrogen product stream 121 is then introduced into natural gas pre-heater 105, where indirectly exchanges heat with natural gas stream 104, exiting as 15 cooled hydrogen product stream 123. In another embodiment, the heat from hot hydrogen stream 121 may be used for preheating BFW.

In one embodiment, air compressor 102 and expander 117 may be mechanically attached. In another embodiment, the power required for air compressor 102 is at least partially provided by the power generated by expander 117. In another embodiment, the power required for air compressor 102 is completely provided by the power generated by expander 117.

The above described process can be optimized by one skilled in the art, depending upon the particular power, steam and hydrogen products requirements. At least the following variables are available for optimization, with the skilled artisan recognizing that other aspects of the proposed invention may also be manipulated to yield further optimized results.

The amount of natural gas that is sent to SMR (stream 108) may be varied to optimize the system. This parameter affects the amount of heat that is used for reforming. The amount of hydrogen that is made in SMR increases when more natural gas is reformed. However increasing the natural gas into the SMR reduces the amount of power that is produced in expander 117, as the exhaust gas temperature (streams 114 and 116) is reduced.

The steam to natural gas ratio may be varied to optimize the system. If the steam to natural gas ratio is increased, the amount of hydrogen that is produced increases. The excess steam that is not used in the reforming of methane will ultimately be sent to expander 117, which will result in increased power production. The desired minimum molar ratio of steam to methane is about 2.0.

SMR 113 contains a catalyst to assist the steam reforming of methane. The catalyst may be in the shape of pellets, granular, tablets etc. The catalyst can also be in the form of a coated monolith or coated tube surface. The catalysts using nickel or noble metals are commercially available.

Hot hydrogen product stream 121, as permeate from the filter 120 is hot and may be at low pressure of less than 50 psig. Heat is recovered from this stream and the product hydrogen is compressed to desired pressure.

The use of heat for hydrogen production improves the efficiency of power generation and hydrogen generation.

This processing scheme differs from the prior art in a number of respects. First the instant process uses higher level heat, upstream of expander 117, for reforming. Second the hot gases that are used in the reforming exchanger are at high pressure, thereby reducing the size of the reforming exchanger. Third the proposed process recovers hydrogen from the reformed gas mixture. Fourth the proposed process removes hydrogen from the gas mixture at elevated temperature, thereby allowing the use of hot residue gas fuel.

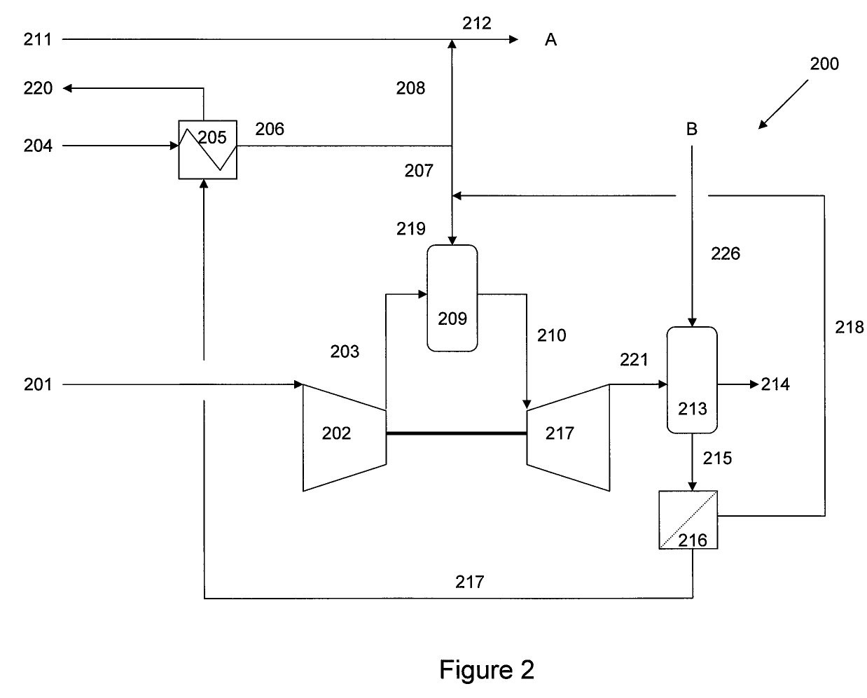

Turning now to FIG. 2, combined SMR and cogeneration system 200 is provided. Combustion air stream 201 is introduced to air compressor 202, where it is compressed and exits as compressed air stream 203. Natural gas stream 204 introduced into natural gas pre-heater 205, where it exits as heated natural gas stream 206. Natural gas stream 204 may be purified if necessary. Heated natural gas stream 206 is divided into at least two portions, combustor feed gas stream 207 and SMR feed gas stream 208. Combustor feed gas stream 207 is combined with compressed air stream 203 in combustor 209, where it is combusted, thereby generating first exhaust gas stream 210. First exhaust gas stream 210 is introduced into expander 217, where it is expanded and exits as second exhaust gas stream 221. Steam stream 211, is combined with SMR feed gas stream 208, to form combined feed stream 212. Combined feed stream 212 is further preheated in a mixed feed preheater section of waste heat boiler 225 (shown in FIG. 2a). Preheated combined feed stream 226 is then introduced into SMR 213, where it exits as syngas stream 215. Second exhaust gas stream 221 is introduced into the shell-side of SMR 213, where it provides the heat required for the steam reforming process, then exiting as third exhaust gas stream 214. Third exhaust gas stream 214 is used for preheating mixed feed stream 212, and for generating steam. Boiler feed water stream 222 is introduced into waste heat boiler 225, wherein it is heated, vaporized, and superheated into steam stream 223. Steam stream 223 may be used to feed the SMR (stream 211), with any remaining steam being available for exportation, or for power generation in a steam turbine (not shown).

In one embodiment, SMR 213 may be of the type known as an exchanger type, which has no burners to supplement the heat content of first exhaust gas stream 203. In another embodiment, SMR 213 may have burners (not shown) to supplement the heat content of first exhaust gas stream 221, as needed. Syngas stream 215 is introduced into filter 216, where it is separated into hot hydrogen product stream 217 and secondary fuel stream 218. Filter 216 may be a ceramic or metallic separator. Secondary fuel stream 218 may contain one or more of the following, unconverted methane, unrecovered H2, CO, CO2, and unused steam. The metallic separator may utilize palladium. Hot hydrogen product stream 217 is then introduced into natural gas pre-heater 205, where indirectly exchanges heat with natural gas stream 204, exiting as cooled hydrogen product stream 220.

In one embodiment, air compressor 202 and expander 217 may be mechanically attached in another embodiment, the power required for air compressor 202 is at least partially provided by the power generated by expander 217. In another embodiment, the power required for air compressor 202 is completely provided by the power generated by expander 217. In one embodiment, third exhaust gas stream 214 may be used for preheating natural gas, preheating a mixed feed to the SMR, for generating steam, or any combination thereof. In one embodiment, the steam that is generated is used to feed the SMR, with any remaining steam being available for exportation, or for power generation in a steam turbine (not shown).

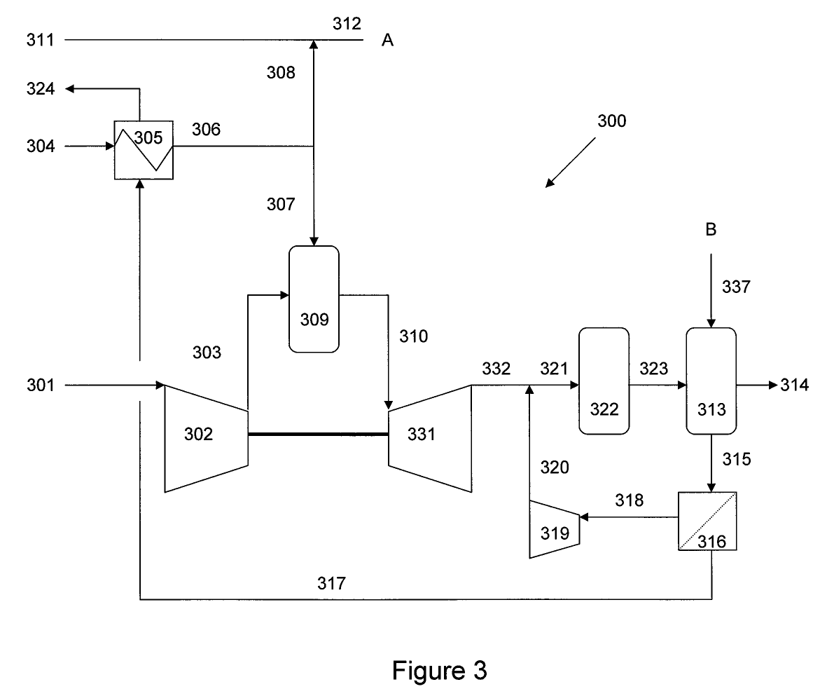

Turning now to FIG. 3, combined SMR and cogeneration system 300 is provided. Combustion air stream 301 is introduced to air compressor 302, where it is compressed and exits as compressed air stream 303. Natural gas stream 304 introduced into natural gas pre-heater 305, where it exits as heated natural gas stream 306. Natural gas stream 304 may be purified if necessary. Heated natural gas stream 306 is divided into at least two portions, combustor feed gas stream 307 and SMR feed gas stream 308. Combustor feed gas stream 307 is combined with compressed air stream 303 in first combustor 309, where it is combusted, thereby generating first exhaust gas stream 310. First exhaust gas stream 310 is introduced into first expander 331, where it is expanded and exits as second exhaust gas stream 332. Steam stream 311, is combined with SMR feed gas stream 308, to form combined feed stream 312. Combined feed stream 312 is further preheated in a mixed feed preheater section of waste heat boiler 336 (shown in FIG. 3a). Preheated combined feed stream 337 is introduced into SMR 313, where it exits as syngas stream 315. In one embodiment, SMR 313 may be of the type known as an exchanger type, which has no burners to supplement the heat content of fourth exhaust gas stream 323. In another embodiment, SMR 313 may have burners (not shown) to supplement the heat content of fourth exhaust gas stream 323, as needed. Fourth exhaust gas stream 323 is introduced into the shell-side of SMR 313, where it provides the heat required for the steam reforming process, then exiting as fifth exhaust gas stream 314. Fifth exhaust gas stream 314 is used for preheating mixed feed stream 312, and for generating steam. Boiler feed water stream 333 is introduced into waste heat boiler 336, wherein it is heated, vaporized, and superheated into steam stream 334. Steam stream 334 may be used to feed the SMR (stream 311), with any remaining steam being available for exportation, or for power generation in a steam turbine (not shown).

Syngas stream 315 is introduced into filter 316, where it is separated into hot hydrogen product stream 317 and secondary fuel stream 318. Filter 316 may be a ceramic or metallic separator. Secondary fuel stream 318 may contain one or more of the following, unconverted methane, unrecovered H2, CO, CO2, and unused steam. The metallic separator may utilize palladium. Secondary fuel stream 318 is introduced into second expander 319, where it is expanded and exits as expanded secondary fuel gas stream 320. Second exhaust gas stream 332 is combined with expanded secondary fuel stream 320 in second combustor 322 where it is combusted, thereby generating fourth exhaust gas stream 323. Hot hydrogen product stream 317 is then introduced into natural gas pre-heater 305, where indirectly exchanges heat with natural gas stream 304, exiting as cooled hydrogen product stream 324.

In one embodiment, air compressor 302 and first expander 331 may be mechanically attached. In another embodiment, the power required for air compressor 302 is at least partially provided by the power generated by at least one of first expander 331 and second expander 319. In another embodiment, the power required for air compressor 302 is completely provided by the power generated by expander 331. In one embodiment, fifth exhaust gas stream 314 may be used for preheating natural gas, preheating a mixed feed to the SMR, for generating steam, or any combination thereof. In one embodiment, the steam that is generated is used to feed the SMR, with any remaining steam being available for exportation, or for power generation in a steam turbine (not shown).

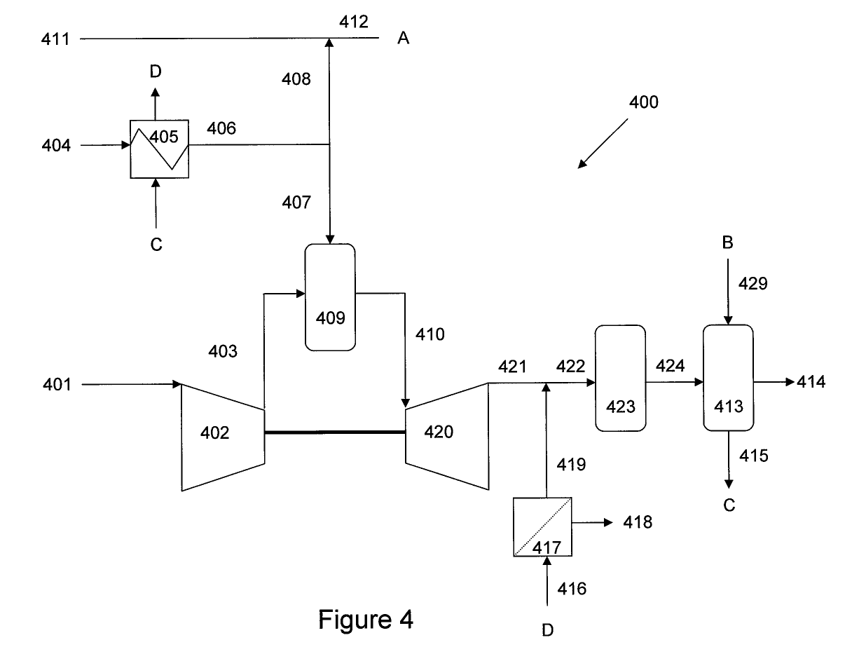

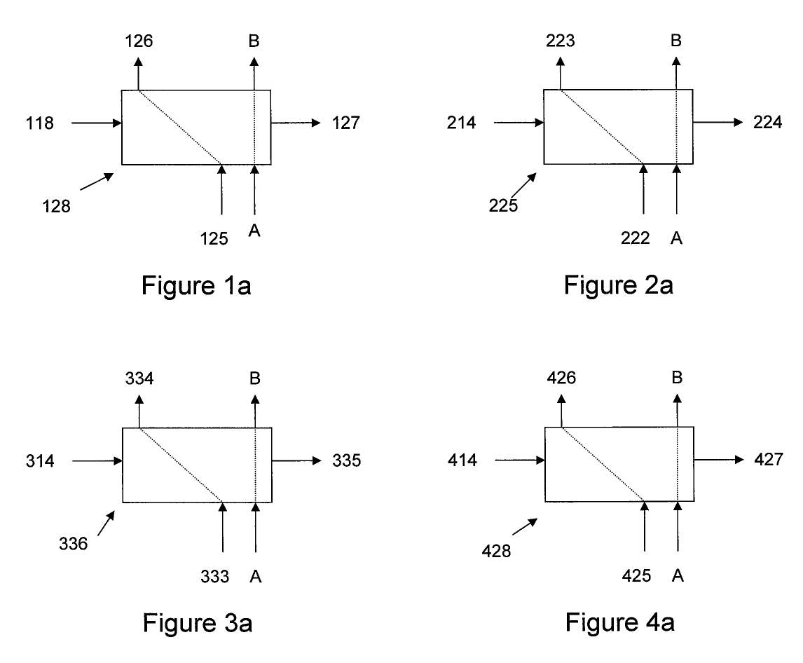

Turning now to FIG. 4, combined SMR and cogeneration system 400 is provided. Combustion air stream 401 is introduced to air compressor 402, where it is compressed and exits as compressed air stream 403. Natural gas stream 404 introduced into natural gas pre-heater 405, where it exits as heated natural gas stream 406. Natural gas stream 404 may be purified if necessary. Heated natural gas stream 406 is divided into at least two portions, combustor feed gas stream 407 and SMR feed gas stream 408. Combustor feed gas stream 407 is combined with compressed air stream 403 in first combustor 409, where it is combusted, thereby generating first exhaust gas stream 410. First exhaust gas stream 410 is introduced into expander 420, where it is expanded and exits as second exhaust gas stream 421. Steam stream 411, is combined with SMR feed gas stream 408, to form combined feed stream 412. Combined feed stream 412 is further preheated in a mixed feed preheater section of waste heat boiler 428 (shown in FIG. 4a). Preheated combined feed stream 429 is introduced into SMR 413, where it exits as syngas stream 415. In one embodiment, SMR 413 may be of the type known as an exchanger type, which has no burners to supplement the heat content of fourth exhaust gas stream 424. In another embodiment, SMR 413 may have burners (not shown) to supplement the heat content of fourth exhaust gas stream 424, as needed. Fourth exhaust gas stream 424 is introduced into the shell-side of SMR 413, where it provides the heat required for the steam reforming process, then exiting as fifth exhaust gas stream 414. Fifth exhaust gas stream 414 is used for preheating mixed feed stream 412, and for generating steam. Boiler feed water stream 425 is introduced into waste heat boiler 428, wherein it is heated, vaporized, and superheated into steam stream 426. Steam stream 426 may be used to feed the SMR (stream 411), with any remaining steam being available for exportation, or for power generation in a steam turbine (not shown).

Syngas stream 415 is introduced into natural gas pre-heater 405, where indirectly exchanges heat with natural gas stream 404, exiting as cooled syngas stream 416. In one embodiment, cooled syngas stream 416 is at approximately ambient temperature. In another embodiment, cooled syngas stream 416 is at approximately 10 degrees warmer than ambient temperature. Cooled syngas stream 416 is introduced into PSA 417, where it is separated into hydrogen product stream 418 and secondary fuel stream 419. Secondary fuel stream 419 may contain one or more of the following, unconverted methane, unrecovered H2, CO, CO2, and unused steam. Secondary fuel stream 419 may be at a pressure of between about 2 psig and about 20 psig. Second exhaust gas stream 421 is combined with secondary fuel stream 419 in second combustor 423 where it is combusted, thereby generating fourth exhaust gas stream 424.

In one embodiment, air compressor 402 and expander 420 may be mechanically attached. In another embodiment, the power required for air compressor 402 is at least partially provided by the power generated by expander 420. In another embodiment, the power required for air compressor 402 is completely provided by the power generated by expander 420. In one embodiment, fifth exhaust gas stream 414 may be used for preheating natural gas, preheating a mixed feed to the SMR, for generating steam, or any combination thereof. In one embodiment, the steam that is generated is used to feed the SMR, with any remaining steam being available for exportation, or for power generation in a steam turbine (not shown).

What is claimed is:

1. A process for the integration of power generation and an SMR, comprising:
Introducing a combustion air stream into a compressor, thereby producing a compressed air stream,
Introducing said compressed air stream and a combustor feed gas stream into a first combustor, thereby producing a first exhaust gas stream,
introducing said first exhaust gas stream into the shell-side of an SMR, thereby providing the heat for the reforming reaction, and generating a syngas stream and a second exhaust gas stream,
introducing said second exhaust gas stream and a secondary fuel stream into a second combustor, thereby producing a third exhaust gas stream,
introducing said third exhaust gas stream into an expander, thereby producing power output and a fourth exhaust gas stream.

2. The process for the integration of power generation and an SMR of claim 1, further comprising:
introducing said syngas stream into a filter, thereby producing said secondary fuel stream and a hot hydrogen product stream,
introducing said hot hydrogen product stream into a natural gas preheater, thereby producing a heated natural gas stream and a cooled hydrogen product stream,
blending a portion of said heated natural gas stream with steam and introduced in to said SMR as a product feed stream, and
introducing the remaining heated natural gas stream into said first combustor as said combustor feed gas stream.

3. The process for the integration of power generation and an SMR of claim 1, wherein said first exhaust gas stream has a temperature of between about 2000 F. and about 2200 F.

4. The process for the integration of power generation and an SMR of claim 1, wherein said syngas stream has a temperature of between about 1200 F. and about 1600 F.

5. The process for the integration of power generation and an SMR of claim 1, wherein said fourth exhaust gas stream has a temperature of between about 800 F. and about 1100 F.

6. The process for the integration of power generation and an SMR of claim 1, wherein said compressor and said expander are mechanically attached.

7. The process for the integration of power generation and an SMR of claim 1, wherein the power required by said compressor is at least partially provide by said expander.

8. The process for the integration of power generation and an SMR of claim 1, wherein the power required by said compressor is entirely provide by said expander.

9. A process for the integration of power generation and an SMR, comprising:
Introducing a combustion air stream into a compressor, thereby producing a compressed air stream,
Introducing said compressed air stream and a combustor feed gas stream into a combustor, thereby producing a first exhaust gas stream,
introducing said first exhaust gas stream into an expander, thereby producing power output and a second exhaust gas stream.
introducing said second exhaust gas stream into the shell-side of an SMR, thereby providing the heat for the reforming reaction, and generating a syngas stream and a third exhaust gas stream,

10. The process for the integration of power generation and an SMR of claim 9, further comprising:
introducing said syngas stream into a filter, thereby producing a secondary fuel stream and a hot hydrogen product stream,
introducing said hot hydrogen product stream into a natural gas preheater, thereby producing a heated natural gas stream and a cooled hydrogen product stream,
blending a portion of said heated natural gas stream with steam and introduced in to said SMR as a product feed stream, and
introducing the remaining heated natural gas stream into said combustor as said combustor feed gas stream.

11. A process for the integration of power generation and an SMR, comprising:
Introducing a combustion air stream into a compressor, thereby producing a compressed air stream,
Introducing said compressed air stream and a combustor feed gas stream into a first combustor, thereby producing a first exhaust gas stream,
introducing said first exhaust gas stream into a first expander, thereby producing power output and a second exhaust gas stream.
blending said second exhaust gas stream with an expanded secondary fuel gas stream and introducing said blended gas stream into a second combustor, thereby producing a third exhaust gas stream,
introducing said third exhaust gas stream into the shell-side of an SMR, thereby providing the heat for the reforming reaction, and generating a syngas stream and a fourth exhaust gas stream,

12. The process for the integration of power generation and an SMR of claim 11, further comprising:
introducing said syngas stream into a filter, thereby producing a secondary fuel stream and a hot hydrogen product stream,
introducing said hot hydrogen product stream into a natural gas preheater, thereby producing a heated natural gas stream and a cooled hydrogen product stream,
blending a portion of said heated natural gas stream with steam and introduced in to said SMR as a product feed stream,
introducing the remaining heated natural gas stream into said first combustor as said combustor feed gas stream, and
expanding said secondary fuel gas stream in a second expander, thereby producing said expanded secondary fuel gas stream.

13. A process for the integration of power generation and an SMR, comprising:
Introducing a combustion air stream into a compressor, thereby producing a compressed air stream,
Introducing said compressed air stream and a combustor feed gas stream into a first combustor, thereby producing a first exhaust gas stream,
introducing said first exhaust gas stream into an expander, thereby producing power output and a second exhaust gas stream.
blending said second exhaust gas stream with a secondary fuel gas stream and introducing said blended gas stream into a second combustor, thereby producing a third exhaust gas stream,
introducing said third exhaust gas stream into the shell-side of an SMR, thereby providing the heat for the reforming reaction, and generating a syngas stream and a fourth exhaust gas stream,

14. The process for the integration of power generation and an SMR of claim 13, further comprising:
introducing said syngas stream into a natural gas preheater, thereby producing a heated natural gas stream and a cooled syngas stream,
blending a portion of said heated natural gas stream with steam and introduced in to said SMR as a product feed stream,
introducing the remaining heated natural gas stream into said first combustor as said combustor feed gas stream, and
introducing said cooled syngas stream into a PSA, thereby producing said secondary fuel stream and a hydrogen product stream,
